(19) United States
(12) Patent Application Publication
(10) Pub. No.: US 2008/0170714 A1
(43) Pub. Date: Jul. 17, 2008

(54) Sound transmitting device

(76) Inventor: Miklos Major, Ambridge, PA (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/653,805

(22) Filed: Jan. 16, 2007

(51) Int. Cl. H04R 1/02

(52) U.S. Cl. 381/87

(57) ABSTRACT

A sound transmitting device configured to fit within an ear canal, such as a hearing aid or a monitor, for example, having first and second portions which are relatively movable with respect to each other. As a result of these relatively moving portions, the device can better accommodate changes in the shape and/or orientation of the ear canal. More particularly, after the device has been fitted into the ear canal, the first and second portions can move relative to each other and comply with a new shape and/or orientation of the ear canal. As a result, it is less likely that the device will impede the change in the ear canal thereby reducing potential discomfort to the user. To facilitate this relative movement, the first and second portions can include at least partially spherical surfaces which are configured to permit relative movement therebetween.

### BACKGROUND

1. Field of the Invention

The present invention generally relates to hearing aids, monitors, and other sound transmitting devices, and, more particularly, to improvements thereof which facilitate their fit within and removal from an ear canal.

2. Description of the Related Art

As known in the art, hearing aids, monitors, and other sound transmitting devices, can be used to improve, and protect, a person's hearing. More particularly, these devices can be used to amplify, or otherwise control, the presentation of sound waves into a person's ear, for example. Previous devices have included housings, and transducers positioned therein, which are configured to be positioned within the ear, to receive electrical signals, or impulses, and convert these electrical impulses into to sound waves. In the past, these devices have included either custom housings, i.e., housings which are intended to fit within a particular person's ear, or universal housings, i.e., housings which are intended to fit within the ear of more than one person.

The custom housings of previous sound transmitting devices have been produced through various manufacturing techniques. For example, in one technique, an impression of a person's ear, including their ear canal, is created and the impression is then used to create a mold. As known in the art, the mold is used to create a housing which is customized to fit snugly within the person's ear, and/or ear canal. As a result of this snug fit, the likelihood of the housing becoming dislodged from the ear canal can be reduced. However, owing to such a snug fit, it is often difficult to remove the housing from the ear canal. As a result, wires extending from the housing are often pulled and/or twisted in order to remove the housing from the ear canal. In some circumstances, this may damage the wires and/or the connection between the wires and the housing.

The universal housings of previous sound transmitting devices have included portions which are relatively immovable with respect to each other. As a result, these housings, while comfortable to the user in some circumstances, can be uncomfortable to the user in other circumstances. More particularly, although the housings may fit comfortably when initially fitted within a person's ear canal, the shape, and/or orientation, of their ear canal can change causing discomfort to the user when the housing obstructs such a change. As known in the art, an ear canal can change shape, and/or orientation, when a person sings, eats, or even talks. As a result, in the past, portions of the universal housing have been at least partially covered in foam, for example, to provide a housing that fits snugly within a person's ear canal yet accommodates some change in the shape of the ear canal. However, such materials can quickly lose their elasticity or can become soiled. Accordingly, these previous devices are often a nuisance. What is needed is an improvement over the foregoing.

### SUMMARY

In various embodiments, the present invention includes a sound transmitting device configured to fit within an ear canal, such as a hearing aid or a monitor, for example, having first and second portions which are relatively movable with respect to each other. As a result of these relatively moving portions, the device can better accommodate changes in the shape and/or orientation of the ear canal. More particularly, after the device has been fitted into the ear canal, the first and second portions can move relative to each other and comply with a new shape and/or orientation of the ear canal. As a result, it is less likely that the device will impede the change in the ear canal thereby reducing potential discomfort to the user. To facilitate this relative movement, in various embodiments, the first portion can include a first partially spherical surface and the second portion can include a second partially spherical surface, wherein the first and second surfaces are configured to permit relative movement therebetween. In at least one embodiment, such relative movement includes relative rotational movement between the first and second portions about more than one axis.

In various embodiments, the present invention includes a sound transmitting device configured to fit in an ear canal, the device including a housing and a removable plate attached thereto. In at least one embodiment, the removable plate includes a notch therein that is configured to receive a fingernail, for example, and facilitate the removal of the housing from the ear canal. In various embodiments, the housing includes a cavity which is configured to receive a transducer and the removable plate is configured to substantially close the cavity and retain the transducer therein. In at least one embodiment, the device includes a connector extending from the plate which is configured to receive a mating connector and place the mating connector and the transducer in electrical communication.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a perspective view of a sound transmitting device in accordance with an embodiment of the present invention;

FIG. 2 is an exploded view of the sound transmitting device of FIG. 1;

FIG. 3 is a cross-sectional view of the sound transmitting device of FIG. 1;

FIG. 4 is a second cross-sectional view of the sound transmitting device of FIG. 1;

FIG. 5 is a perspective view of the retaining cap of the sound transmitting device of FIG. 1;

FIG. 6 is a perspective view of the nozzle of the sound transmitting device of FIG. 1;

FIG. 7 is a cross-sectional view of the nozzle of FIG. 6;

FIG. 8 is a perspective view of the locator of the sound transmitting device of FIG. 1;

FIG. 9 is a perspective view of the transducer of the sound transmitting device of FIG. 1;

FIG. 10 is a perspective view of the housing of the sound transmitting device of FIG. 1;

FIG. 11 is a cross-sectional view of the housing of FIG. 10;

FIG. 12 is a perspective view of the connector of the sound transmitting device of FIG. 1;

FIG. 13 is a perspective view of a sound transmitting device having a custom housing and a removable plate attached to the housing;

FIG. 14 is a perspective view of a removable plate of a sound transmitting device in accordance with an embodiment of the present invention;

FIG. 15 is a top view of the removable plate of FIG. 14;

FIG. 16 is a side view of the removable plate of FIG. 14; and

FIG. 17 is a cross-sectional view of the removable plate of FIG. 14.

Corresponding reference characters indicate corresponding parts throughout the several views. The exemplifications set out herein illustrate preferred embodiments of the invention, in one form, and such exemplifications are not to be construed as limiting the scope of the invention in any manner.

### DETAILED DESCRIPTION

Sound transmitting devices, including hearing aids and monitors, for example, can be used to amplify, or otherwise control, the presentation of sound waves into a person's ear. For example, hearing aids can be used to receive sound waves, amplify the sound waves, and transmit the amplified sound waves into the ear of a person who may be hearing impaired, for example. In at least one embodiment, the hearing aid can be configured to only amplify sound waves having particular frequencies. For example, in various embodiments, the hearing aid can include an aperture extending therethrough which is tuned to amplify a specific range of frequencies. In at least one embodiment, the aperture can be tuned via the selection of the length and diameter of the aperture.

In various embodiments, the hearing aid can include a transducer for receiving electrical signals, or impulses, transmitted thereto and for generating sound waves which correspond to the electrical impulses in a predetermined manner. Similar to the above, monitors can be used to control the intensity of sound waves presented into the ear. In many circumstances, monitors can be used to block high-intensity sound waves from directly entering into the ear and reduce the intensity of the sound waves via a transducer, for example, before the sound waves are transmitted into the ear. In these embodiments, the user can be protected from high-intensity sound waves yet still be able to hear their surrounding environment.

Sound transmitting devices can include a first portion which is configured to fit within the pinna of an ear, for example, and a second portion which is configured to fit within the ear canal extending between the outer and middle portions of the ear. The first portion can be configured to engage the pinna of the ear such that it fits snugly therein. In various embodiments, the first portion can be held in place by a mount which extends behind or attaches to the helix and/or anti-helix of the ear, for example. The second portion can be configured to engage the walls of the ear canal such that it snugly fits therein and/or it can be held in place by the first portion and mount described above. In other various embodiments, the sound transmitting device can be completely positioned within the ear canal, pinna, or another portion of the outer ear.

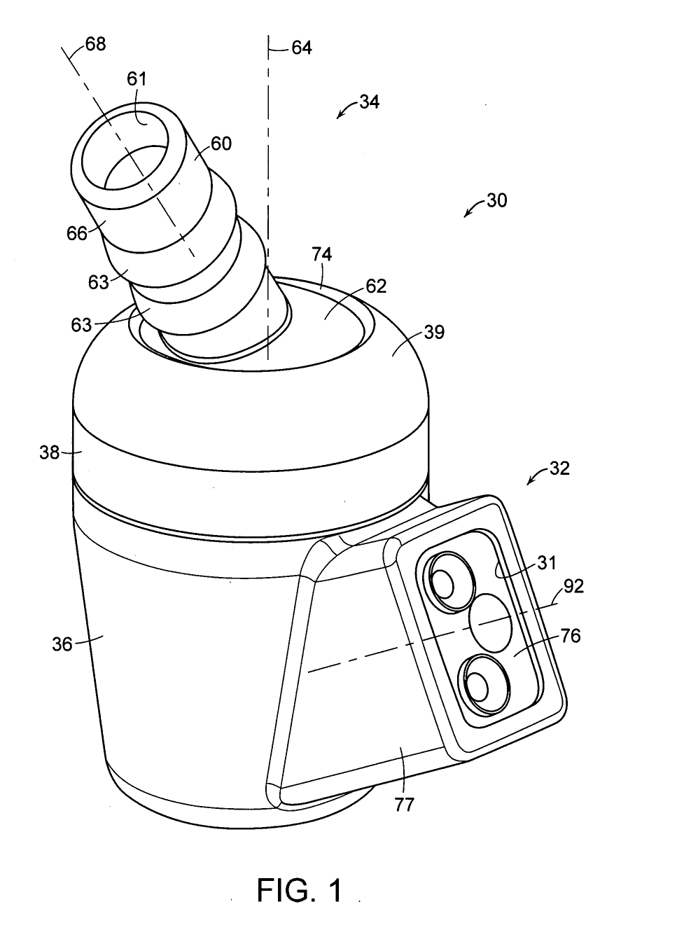

In previous devices, however, the first and second portions of the sound transmitting device are fixed, or immovable, with respect to each other. As a result, as described above, these previous devices are unable to accommodate changes in the shape, or orientation, of the ear canal and can cause discomfort to the user, for example. In accordance with an embodiment of the present invention, referring to FIGS. 1-4, sound transmitting device 30 can include first portion 32 and second portion 34 which are relatively movable with respect to each other. In use, as a result, device 30 can accommodate changes in the shape, or orientation, of an ear canal. For example, in embodiments in which second portion 34 is positioned within an ear canal, first portion 32 and second portion 34, as discussed in detail further below, can move relative to each other when changes in the ear canal causes second portion 34 to translate and/ or rotate with respect to first portion 32.

Referring to FIGS. 1-4, first portion 32 of sound transmitting device 30 can include housing 36 and retaining cap 38 which can define cavity 40. Cavity 40 can be configured to receive transducer 42 and locator 44 where, in various embodiments, locator 44 can hold transducer 42 in position and reduce relative movement between transducer 42 and housing 36. More particularly, locator 44 can include legs 46 extending therefrom which can be positioned on opposite sides of transducer 42 and engage sides 43 of transducer 42 such that transducer 42 is held therebetween. In at least one embodiment, at least one of legs 46 can flex outwardly when transducer 42 is positioned therebetween such that legs 46 grip transducer 42. As a result, the likelihood of transducer 42 moving within cavity 40 can be reduced and thus the likelihood of such movement creating rattling sounds can also be reduced.

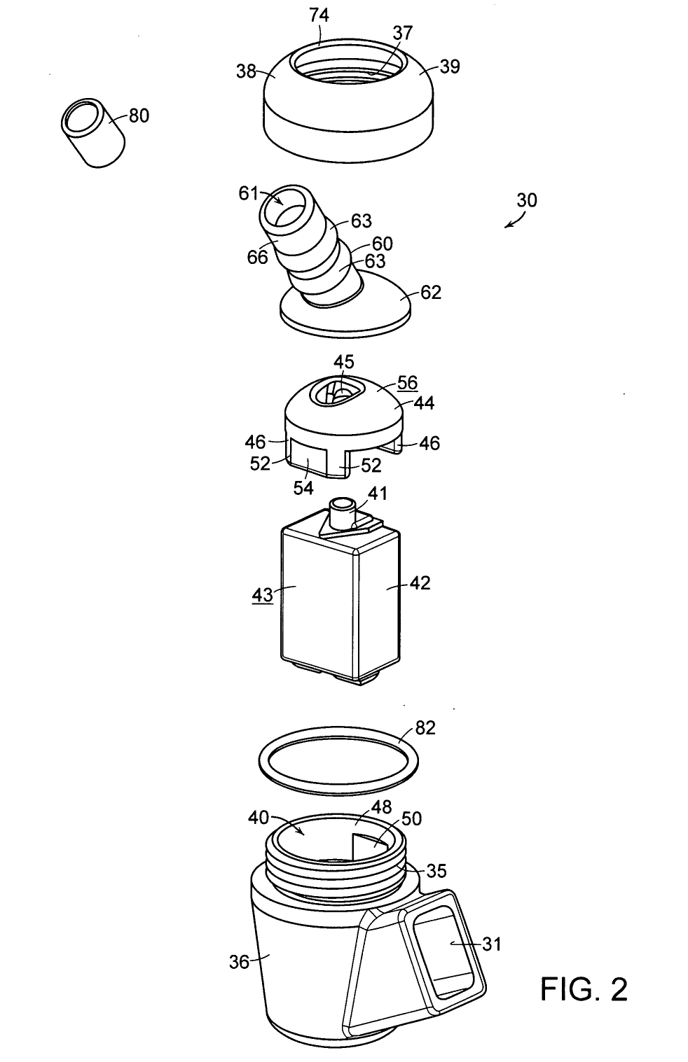

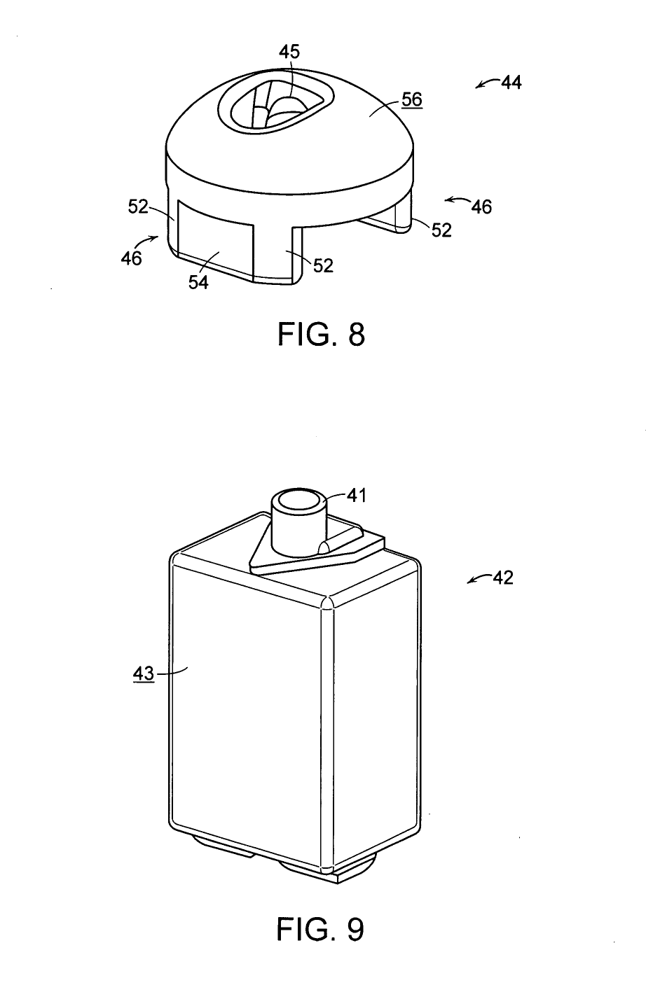

In various embodiments, housing 36 and locator 44 can include features which limit, or even prevent, relative movement between housing 36 and locator 44. In at least one embodiment, for example, housing 36 and locator 44 can include co-operating geometries which prevent relative rotational movement. In the illustrated embodiment, referring to FIGS. 2, 10 and 11, the perimeter of cavity 40 within housing 36 can be defined by arcuate portions 48 and flat portions 50. Similarly, referring to FIGS. 2 and 8, legs 46 of locator 44 can define a perimeter which includes arcuate portions 52 and flat portions 54. During the assembly of locator 44 to housing 36, flat portions 54 of locator 44 can be aligned with flat portions 50 of housing 36 before locator 44 is inserted into cavity 40. Thereafter, as a result of these flat portions, the relative rotational movement of locator 44 within cavity 40 can be limited and, furthermore, when locator 44 is closely received within cavity 40, relative rotational movement therebetween can be prevented.

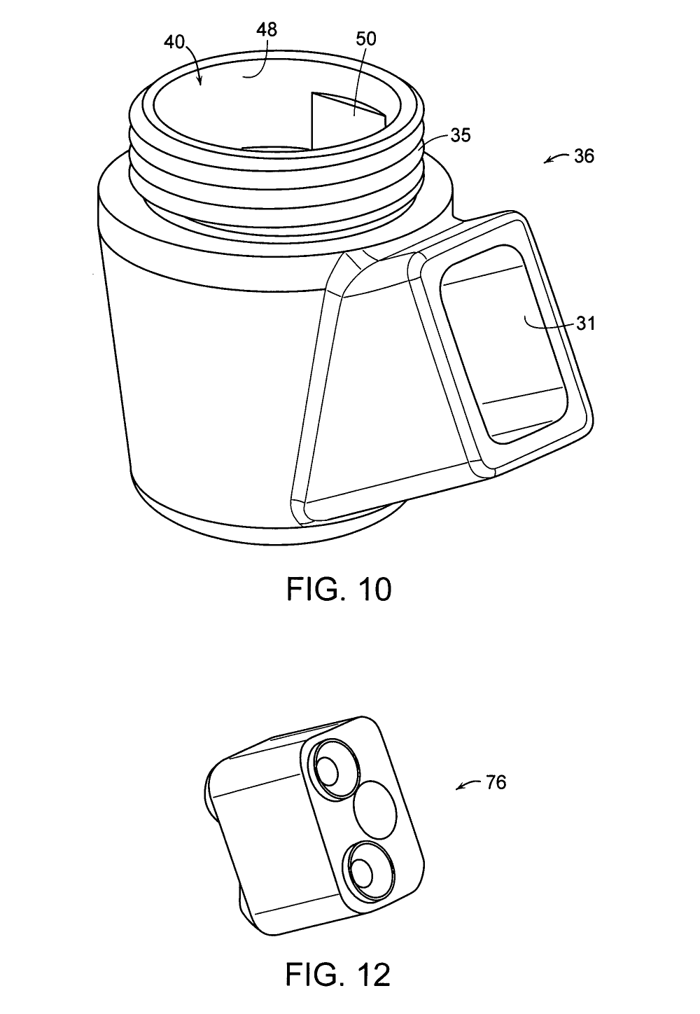

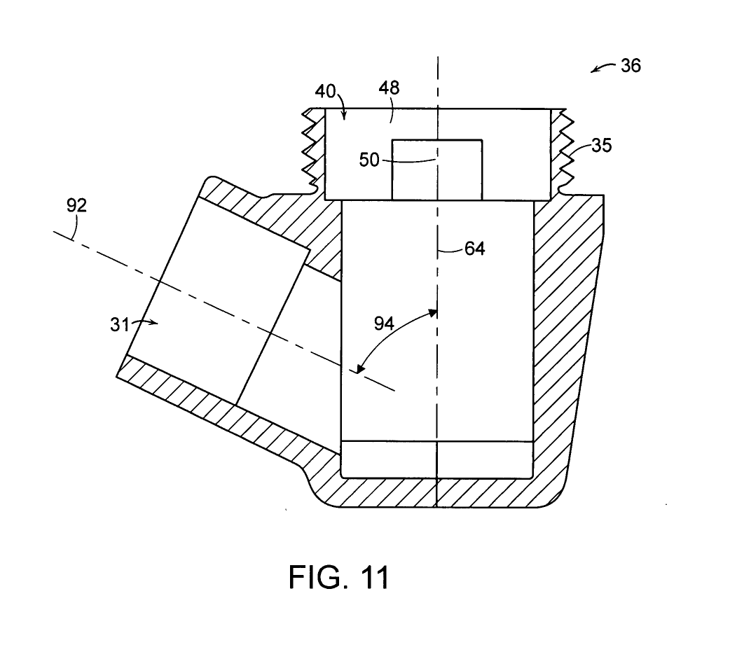

In the illustrated embodiment, referring to FIG. 8, legs 46 of locator 44 can define a substantially symmetrical profile, i.e., legs 46 can include substantially similar, or even identical, arcuate portions 52 and flat portions 54, for example. Furthermore, referring to FIGS. 10 and 11, arcuate portions 48 and flat portions 50 of housing 36 can also define a substantially symmetrical profile which is configured to receive the substantially symmetrical profile of locator 44. As a result, flat portions 54 of locator 44 can be aligned with flat portions 50 of housing 36 in one of two orientations. More particularly, locator 44 can be aligned with housing 36 in the orientation illustrated in FIG. 2, or, alternatively, in an orientation in which locator 44 is rotated 180 degrees from its orientation illustrated in FIG. 2. As a result, for example, locator 44 can be oriented in one direction for devices which are intended to fit in a left ear and oriented in the other direction for devices which are intended to fit in a right ear. In other various embodiments, legs 46 can define a profile which is not symmetrical such that locator 44 can be positioned within housing 36 in only one orientation

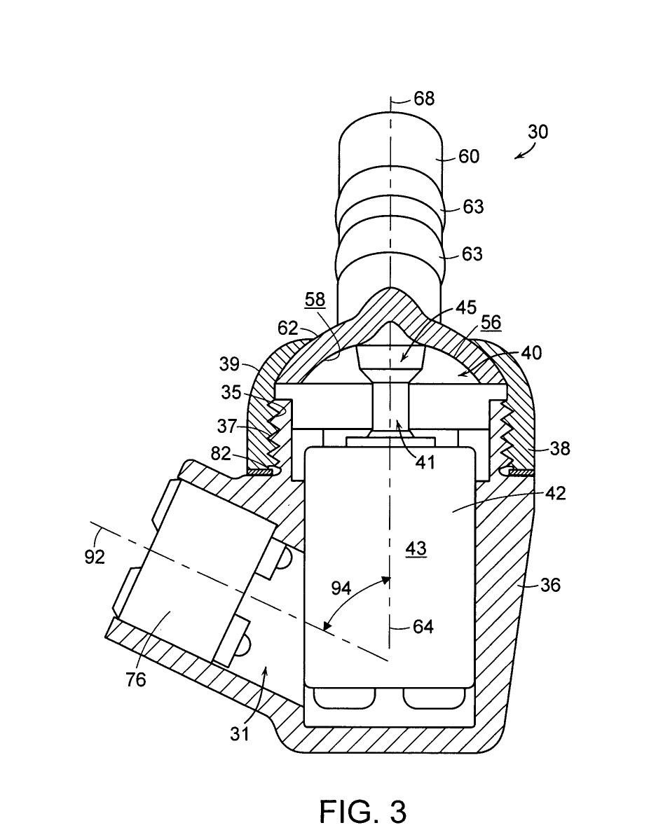

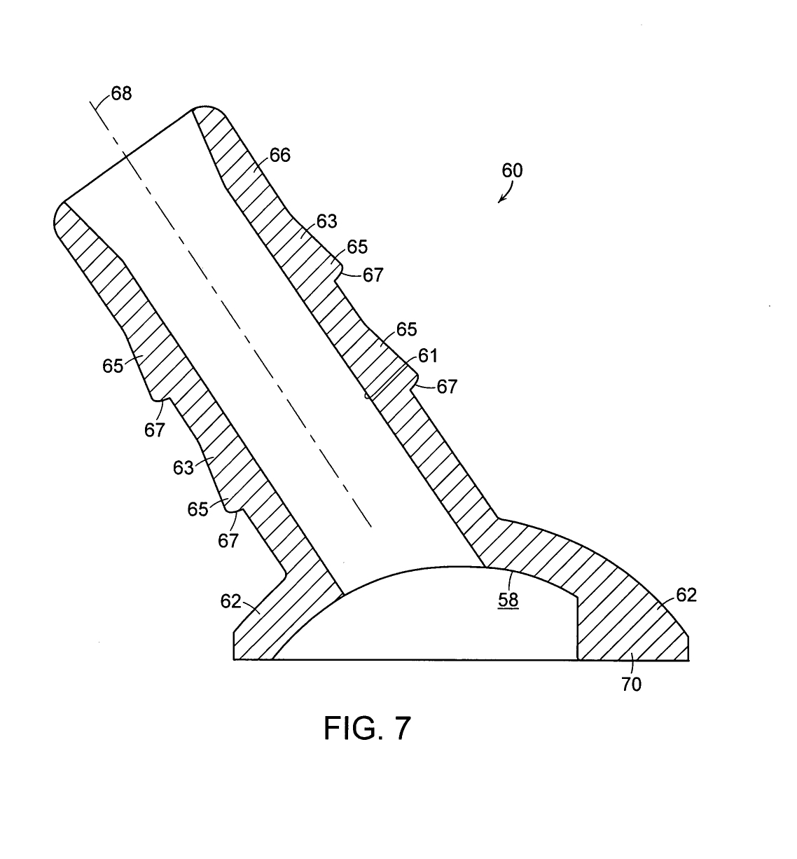

In various embodiments, locator 44 can further include features which facilitate relative movement between first portion 32 and second portion 34, as described above. More particularly, referring to FIGS. 2 and 8, locator 44 can include at least partially spherical surface 56 which is configured to co-operate with at least partially spherical surface 58 (FIGS. 3 and 7) of nozzle 60 to facilitate relative movement between locator 44 and nozzle 60. In various embodiments, surface 56 of locator 44 can be defined by a radius of curvature which is substantially equal to, or parallel to, a radius of curvature which defines surface 58 of nozzle 60. In other embodiments, surfaces 56 and 58 can be defined by several radiuses of curvature, or other profiles, which facilitate relative movement therebetween. In at least one embodiment, surface 56 of nozzle 44 can support nozzle 60 thereon such that surface 58 of nozzle 60 can slide across surface 56 when nozzle 60 is moved relative to locator 44. In various embodiments, at least one of surfaces 56 and 58 can be coated with a lubricant, or other material, which facilitates relative movement therebetween. In at least one embodiment, a rubber sheet, for example, can be inserted between surfaces 56 and 58 to facilitate such relative movement. In various embodiments, surface 56 of locator 44 can define a convex surface which is configured to nest within a concave surface defined by surface 58 of nozzle 60.

In various embodiments, device 30 can further include retaining cap 38 which can be configured to capture a portion of nozzle 60 between retaining cap 38 and locator 44. More particularly, referring to FIGS. 3-5, retaining cap 38 can include arcuate portion 39 which is configured to extend over arcuate portion 62 of nozzle 60 and retain nozzle portion 62 between arcuate portion 39 and locator 44. In various embodiments, arcuate portion 39 of retaining cap 38 and locator 44 can define a gap therebetween which permits the free movement of surface 58 of nozzle 60 with respect to surface 56 of locator 44. In other embodiments, retaining cap 38 can bias nozzle portion 62 against surface 56 of locator 44 such that the movement of surface 58 relative to surface 56 is at least partially inhibited by friction between nozzle 60, retaining cap 38 and locator 44. Referring to FIG. 2, this biasing force can be generated by a threaded connection between retaining cap 38 and housing 36. More particularly, housing 36 can include threads 35 and retaining cap 38 can include threads 37 wherein the threaded engagement of threads 35 and 37 can cause arcuate portion 39 of retaining cap 38 to contact nozzle portion 62 and hold it against surface 56 of locator 44.

In various embodiments, referring to FIG. 1, nozzle 60 can be rotated entirely about axis 64, i.e., nozzle 60 can be rotated 360 degrees about axis 64. In these embodiments, the relative position of nozzle 60 with respect to housing 36, for example, can be adjusted by grasping nozzle shaft 66 and moving nozzle 60 relative to housing 36. Alternatively, nozzle shaft 66 can be positioned within an ear canal, for example, and first portion 32 can then be rotated with respect to shaft 66 in order to position first portion 32 within the outer ear, for example. In various embodiments, especially in embodiments where surfaces 56 and 58 are defined by at least partially arcuate surfaces, nozzle 60 can be rotated such that nozzle shaft 66 can be moved closer to and/or further away from axis 64. More particularly, referring to FIG. 1, the angle between axis 64 and axis 68, wherein axis 68 is defined by nozzle shaft 66, can be increased or decreased in order to position nozzle shaft 66 relative to first portion 32. In effect, nozzle 60 can be rotated about an axis which is transverse or skew with respect to axis 64. In various embodiments, as a result, nozzle 60 can be rotated about at least two axes, i.e., axis 64, as described above, and an axis that is transverse or skew with respect to axis 64.

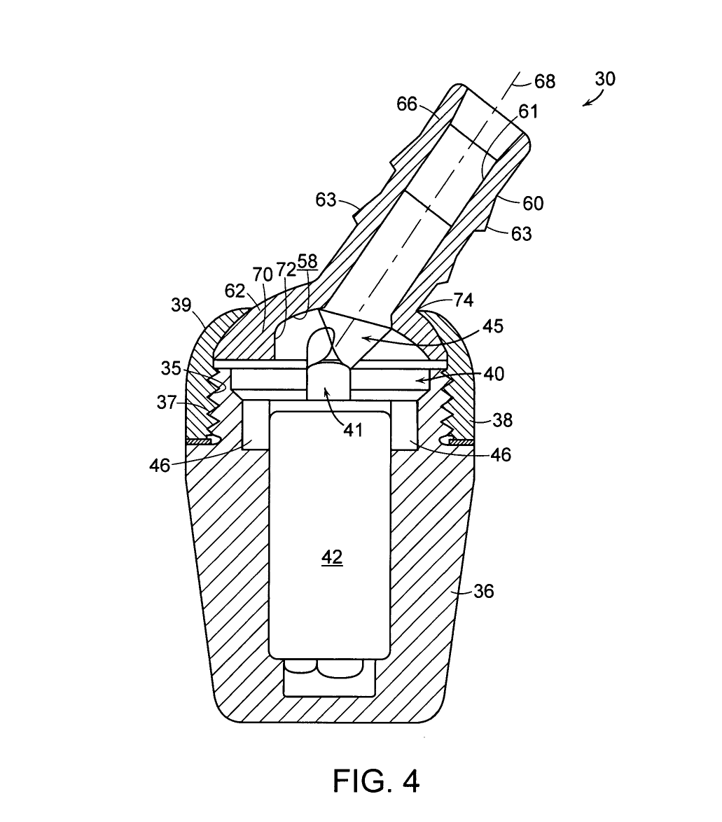

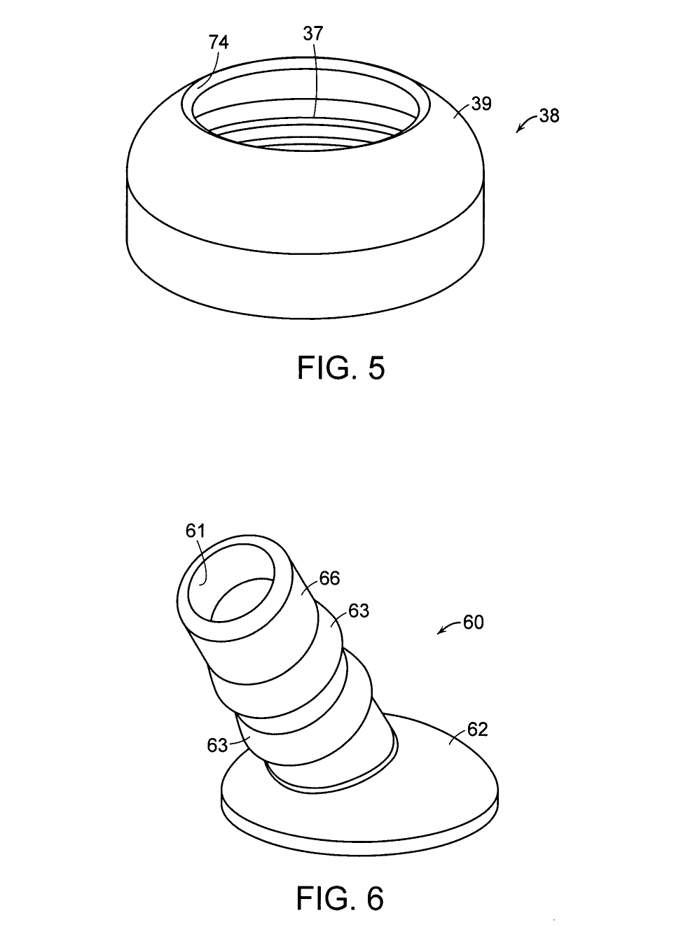

In various embodiments, nozzle 60 can include features which limit the relative movement between nozzle 60 and first portion 32. More particularly, referring to FIGS. 4 and 7, nozzle 60 can include projection 70 extending from arcuate portion 62 which is sized and configured to fit within recess 72 in locator 44. Recess 72, in at least one embodiment, is larger than projection 70 such that projection 70 can move within recess 72. As a result, the range of motion of nozzle 60 with respect to locator 44 can be defined by the geometries of projection 70 and recess 72. Stated another way, the walls of recess 72 can confine projection 70 such that the relative movement of nozzle 60 with respect to locator 44 is limited. In these embodiments, it may be preferable to limit the relative movement between nozzle 60 and first portion 32 to prevent a gross misalignment between nozzle shaft 66 and the ear canal. In the present embodiment, projection 70 and recess 72 are substantially rectangular, however, other configurations are possible. For example, in various embodiments, at least one of projection 70 and recess 72 can be circular, or arcuate. In at least one embodiment, recess 72 can define a circumferential or curvilinear groove at least partially extending around axis 64 which can limit the relative movement between nozzle 60 and locator 44 along a fixed path.

In addition to or in lieu of the above, retaining cap 38 can include features for limiting the relative movement between nozzle 60 and first portion 32. More particularly, referring to FIGS. 1-5, retaining cap 38 can include aperture 74 which is configured to permit nozzle shaft 66 to extend therethrough. In these embodiments, nozzle 60 can be moved with respect to locator 44, as described above, through a range of motion defined by the perimeter of aperture 74. More particularly, nozzle shaft 66 can be moved within aperture 74 until a portion of nozzle shaft 66 abuts the perimeter of aperture 74. In addition, aperture 74 can also be configured to prevent nozzle 60 from being dislodged from device 30. More particularly, in various embodiments, the perimeter of arcuate portion 62 can be larger than the perimeter of aperture 74 such that arcuate portion 62 cannot pass through aperture 74.

In various embodiments, as described above, transducer 42 can be used to generate sound waves which correspond to electrical signals transmitted thereto. For example, transducer 42 can include a wireless receiver which is configured to receive transmissions from a remote source. In addition to or in lieu of the above, device 30 can include connector 76 which is configured to receive signals from a wiring harness connected thereto. More particularly, referring to FIGS. 1-3, connector 76 can be positioned and secured within cavity 31 of housing 36 and can include three terminals, or pins, which are in electrical communication with transducer 42 either directly or through wires (not illustrated). In at least one embodiment, these three terminals can provide both power and a signal transmission to transducer 42. In various embodiments, connector 76 can be configured to receive a mating connector which operably connects thereto and places transducer 42 in electrical communication with a signal transmitter positioned outside of device 30 via a wiring harness, for example.

Referring to FIGS. 2-4, transducer 42 can be positioned within cavity 40 such that sound waves generated by transducer 42 are conducted therefrom into nozzle shaft 66. More particularly, locator 44 and nozzle 62 can define a path therethrough which places transducer 42 and nozzle shaft 66 in acoustic communication. Referring to FIGS. 2-4 and 8, locator 44 can include aperture 45 which is aligned with end 41 of transducer 42 wherein aperture 45 can be configured to conduct sound waves from transducer 42 into aperture 61 (FIG. 7) in nozzle shaft 66. In various embodiments, the cross-sectional profile and length of aperture 61 can be configured to conduct sound waves therethrough and, in some embodiments, amplify sound waves having certain frequencies, or ranges of frequencies. In various embodiments, referring to FIG. 2, aperture 61 can be configured to receive filter 80 which can attenuate, or otherwise alter, the sound waves passing therethrough.

In various embodiments, referring to FIGS. 1-4, nozzle 60 can further include ridges 63 protruding from nozzle shaft 66. In various embodiments, ridges 63 can be configured to receive and retain a tip (not illustrated) on nozzle shaft 66. In at least one embodiment, the tip can be comprised of foam, rubber, or any other suitable material, for engaging the walls of the ear canal. In at least one embodiment, the tip can create a substantially sound-tight seal between nozzle shaft 66 and the walls of the ear canal. As a result of this sound-tight seal, the sound waves introduced into the ear canal can be controlled and substantially limited to the sound waves produced by device 30. In various embodiments, the tip can be removable and can be replaced when it becomes spoiled or loses its elasticity, for example. In at least one embodiment, referring primarily to FIG. 7, ridges 63 can include ramps 65 which facilitate the insertion of the tip onto nozzle shaft 66 and walls 67 which can be configured to co-operate with features on the tip to retain the tip thereon.

In addition to the above, in various embodiments, device 30 can further include seals which can create a water-tight and/or sound-tight seal between two adjacent components of device 30. More particularly, referring to FIG. 1, device 30 can include an O-ring seal, i.e., seal 82, which is configured to seal the connection between retaining cap 38 and housing 36. In use, as retaining cap 38 is threaded onto housing 36, as described above, retaining cap 38 can compress seal 82 between portions of retaining cap 38 and housing 36. In at least one embodiment, seal 82 can be comprised of rubber or any other suitable material. In embodiments in which seal 82 creates a sound-tight seal between retaining cap 38 and housing 36, seal 82 can substantially prevent sound waves from escaping from cavity 40 and, in addition, it can prevent ambient sound waves from entering into cavity 40. Such sound waves, if they were to enter into cavity 40, for example, could interfere with the presentation of sound waves into the ear canal by device 30.

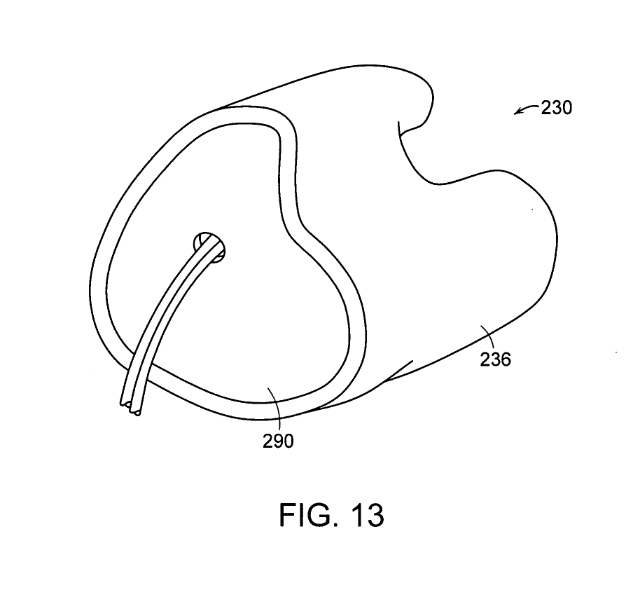

In various embodiments of the present invention, the sound transmitting device can fit snugly within a person's ear canal. In some circumstances, however, the device can be somewhat difficult to grasp and manipulate, especially when the device is contoured such that it closely fits to the anatomical structures of the ear surrounding the device. As a result, the user may often remove the device from their ear by pulling on the wires extending from the device. Accordingly, in some circumstances, the wires, and/or their connection to the device, may become damaged. Referring to FIG. 13 which illustrates a previous sound transmitting device, the device does not include convenient features which facilitate the removal of the device from an ear.

Referring to FIG. 1, sound transmitting device 30 of the present invention can include connector mount 77 extending from housing 36 wherein connector mount 77 can be sized and configured for the user to grasp device 30 via connector mount 77. More particularly, in use, the user can place a finger on a wire extending from device 30, follow the wire with their finger until it reaches the connector mated to connector 76, and then grasp connector mount 77 which is located proximally to connector 76. In this way, the user is provided with a method of locating a convenient feature on device 30 for removing device 30 from their ear.

In various embodiments, the orientation of connector mount 77 with respect to housing 36 can facilitate the removal of device 30 from the user's ear. Referring primarily to FIGS. 1, 3 and 11, connector mount 77 can define an axis, i.e., axis 92, which is transverse to the surface of housing 36 and/or axis 64. In at least one embodiment, axis 92 is not perpendicular to axis 64. In various embodiments, axis 92 and axis 64 can define angle 94 (FIGS. 3 and 11) therebetween which is less than 90 degrees and, in other embodiments, greater than 90 degrees. In the illustrated embodiment, angle 94 is approximately 65 degrees. Angle 94 can be configured such that connector mount 77 is oriented in a direction which can be easily grasped by the user and, in some embodiments, does not abut the outer ear of the user. However, in some circumstances, connector mount 77 can be readily visible to other people when positioned in a user's ear which can subvert the user's desire to reduce the visibility of such a sound transmitting device within their ear.

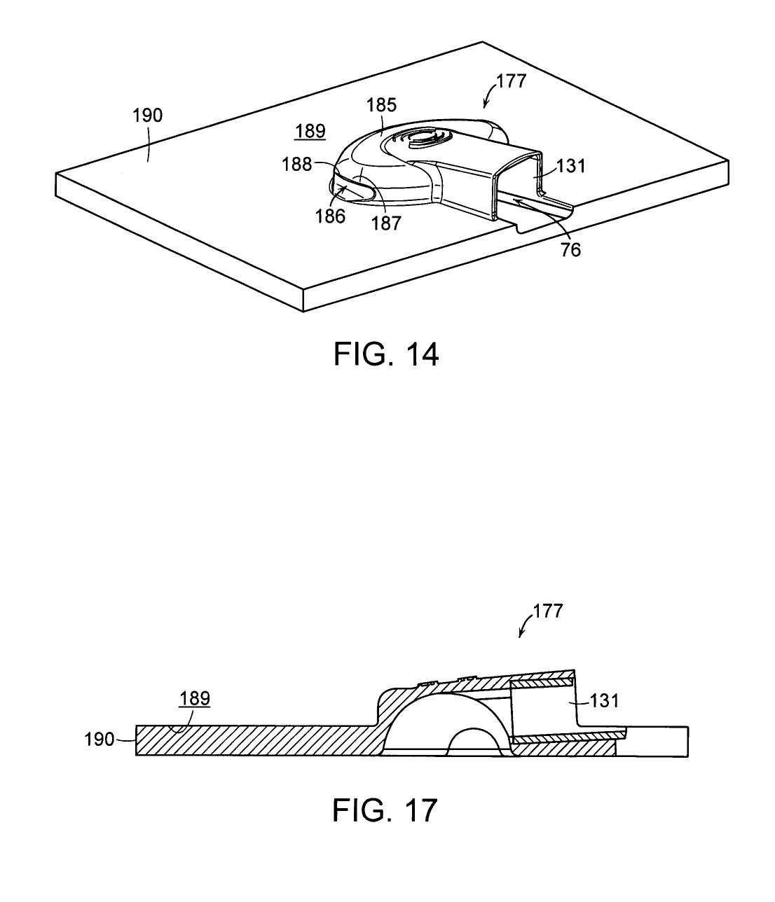

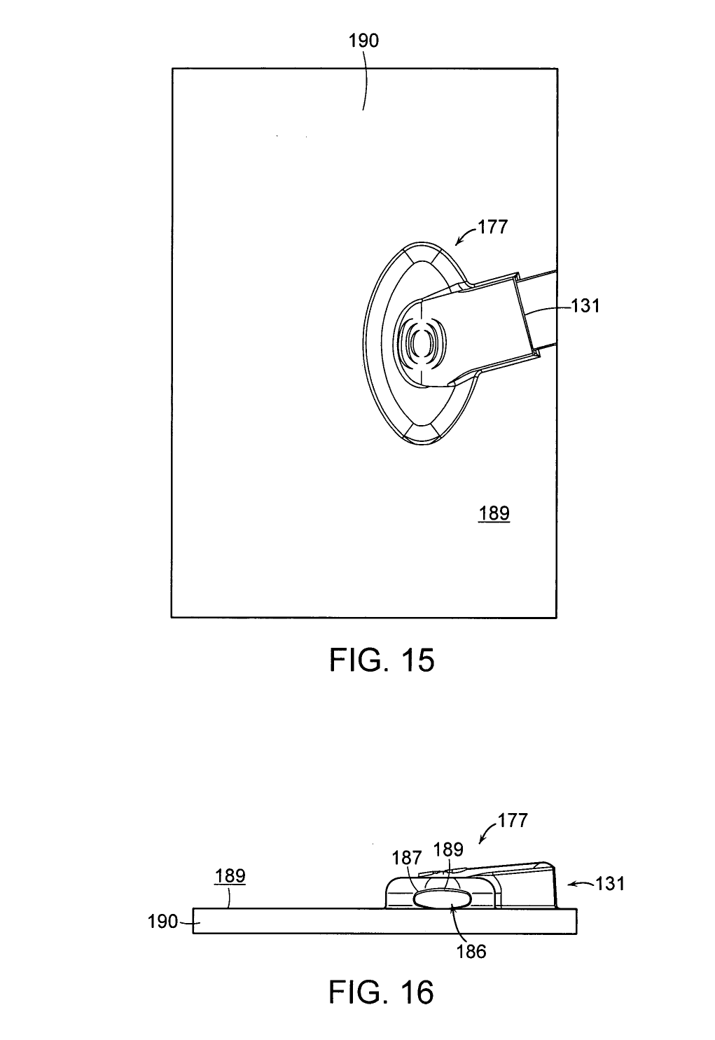

Alternative connector mount 177 is illustrated in FIGS. 14-17. Similar to the above, connector mount 177 can include cavity 131 which is configured to receive and retain connector 76 therein. Connector mount 177 can further include dome 185 protruding from surface 186 of the connector device. In use, similar to the above, a user may follow the wires and mating connector operably connected to the device in order to locate dome 185. Alternatively, owing to the raised profile of dome 185, the user may locate the edges and or the center of dome 185 by placing their finger directly on the device. Thereafter, referring to FIGS. 14 and 16, the user can position their fingernail, for example, within notch 186 in dome 185. Notch 186 can be configured to receive a user's fingernail and permit the user to pry, or otherwise remove, the device from their ear. In various embodiments, notch 186 can be substantially hidden from plain view. For example, in at least one embodiment, notch 186 can be defined between surface 186 and overhang 187 extending from dome 185. In this embodiment, the user can place their fingernail underneath overhang 187 and apply force to the device. In the illustrated embodiment, referring to FIG. 14, overhang 187 can be defined by arcuate edge 188 which can provide a point 189 at which the removal force can be applied.

In various embodiments, connector mount 177 can extend from a sound transmitting device having a custom housing or a universal housing. A custom housing can be produced by creating an impression of a person's ear, including their ear canal, and using the impression to create a mold. The mold can then be used to create a housing which is customized to fit snugly within the person's ear, and/or ear canal. More particularly, a soft compound, such as a silicone-based impression material, for example, can be inserted into the person's ear and can be compressed, and otherwise shaped, to conform to the anatomy of their ear. The impression can then be removed from the ear, encased in a plastic material, for example, and then permitted to cure and harden. Thereafter, the encasement can be cut and the impression removed therefrom leaving behind a cavity which can receive material to form the housing. Once cured, the housing can be removed from the encasement and can be assembled with the other components of the sound transmitting device. Referring to FIG. 13, a sound transmitting device 230 can include a custom housing 236 having a cavity located therein. In at least one embodiment, the cavity can be configured to receive electronics, such as a transducer, for example. To at least substantially close the cavity, the device can further include removable plate 290 connected to housing 236. Referring to FIGS. 14-17, which illustrates an embodiment of the present invention, connector mount 177 of the present invention can extend from removable plate 190.

While this invention has been described as having exemplary designs, the present invention may be further modified within the spirit and scope of the disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An apparatus for transmitting sound, comprising:
a housing; and
a nozzle, wherein said nozzle is configured to at least partially fit within an ear canal, wherein said nozzle includes a passage extending therethrough which is in acoustic communication with said housing, and wherein said nozzle is relatively movable with respect to said housing.

2. The apparatus of claim 1, wherein said apparatus further comprises a transducer, wherein said transducer is configured to convert electrical impulses into sound waves, and wherein said nozzle passage is configured to conduct said sound waves into said ear canal.

3. The apparatus of claim 2, wherein said apparatus further comprises a connector, and wherein said connector is configured to receive a mating connector and conduct said electrical impulses to said transducer.

4. The apparatus of claim 3, further comprising a notch in said connector, wherein said notch is configured to receive a fingernail and facilitate the removal of said nozzle from said ear canal

5. The apparatus of claim 2, wherein said housing includes a cavity, and wherein at least a portion of said transducer is configured to fit within said cavity.

6. The apparatus of claim 1, wherein said apparatus further includes a first at least partially spherical surface, wherein said nozzle includes a second at least partially spherical surface, and wherein said first surface and said second surface are configured to permit relative movement therebetween.

7. The apparatus of claim 6, wherein said relative movement includes relative rotational movement about more than one axis.

8. The apparatus of claim 6, wherein said relative movement includes relative sliding movement.

9. The apparatus of claim 1, wherein said apparatus further includes a locator, wherein said housing and said locator are configured to limit relative rotational movement therebetween, wherein one of said locator and said nozzle includes a concave surface and the other of said locator and said nozzle includes a convex surface, and wherein said concave surface and said convex surface are configured to permit relative rotational movement therebetween.

10. The apparatus of claim 9, wherein said housing includes a cavity, wherein said cavity is configured to receive at least a portion of said locator, and wherein said cavity and said locator include at least partially non-circular profiles which co-operate to limit relative rotational movement therebetween.

11. The apparatus of claim 1, wherein said apparatus further comprises a retaining cap, wherein said retaining cap includes threads, wherein said housing includes threads, and wherein said housing and said retaining cap are configured to be threadably connected via said retaining cap threads and said housing threads and capture at least a portion of said nozzle in a cavity defined by said housing and said retaining cap.

12. An apparatus for transmitting sound, comprising:
a first portion; and
a second portion, wherein said second portion is configured to at least partially fit within an ear canal, wherein said second portion is relatively movable with respect to said first portion.

13. The apparatus of claim 12, wherein said apparatus further comprises a transducer, wherein said second portion includes a passage extending therethrough, wherein said transducer is configured to convert electrical impulses into sound waves, and wherein said passage is configured to conduct said sound waves into said ear canal.

14. The apparatus of claim 12, wherein said first portion includes a first at least partially spherical surface, wherein said second portion includes a second at least partially spherical surface, and wherein said first surface and said second surface are configured to permit relative movement between said first portion and said second portion.

15. The apparatus of claim 14, wherein said relative movement includes relative rotational movement about more than one axis.

16. The apparatus of claim 12, wherein one of said first portion and said second portion includes a concave surface and the other of said first portion and said second portion includes a convex surface, and wherein said concave surface and said convex surface are configured to permit relative rotational movement therebetween.

17. An apparatus for transmitting sound, comprising:
a first portion;
a second portion, wherein said second portion is configured to at least partially fit within an ear canal; and
means for moving said second portion relative to said first portion.

18. The apparatus of claim 17, wherein said means includes a first at least partially spherical surface and a second at least partially spherical surface, and wherein said first surface and said second surface are configured to permit relative movement between said first portion and said second portion.

19. The apparatus of claim 17, wherein said means includes means for moving said second portion relative to said first portion about more than one axis.

20. The apparatus of claim 17, wherein said means includes a concave surface and a convex surface, and wherein said concave surface and said convex surface are configured to permit relative rotational movement between said first portion and said second portion.

21. An apparatus for transmitting sound, comprising:
a housing, wherein said housing defines a first axis; and
a connector, wherein said housing includes a connector mount configured to receive said connector, wherein said connector is configured to receive a mating connector, and wherein said connector mount defines a second axis that is transverse, but not perpendicular, to said first axis.

22. The sound transmitting device of claim 21, wherein said first axis and said second axis define an angle therebetween that is less than 90 degrees.

23. The sound transmitting device of claim 21, wherein said first axis and said second axis define an angle therebetween that is approximately 65 degrees.

24. The sound transmitting device of claim 21, wherein said sound transmitting device further includes a transducer, wherein said housing includes a cavity configured to receive said transducer, wherein said transducer is configured to convert electrical impulses into sound waves, and wherein said cavity defines said first axis.
